(19) United States
(12) Patent Application Publication
(10) Pub. No.: US 2011/0107869 A1
(43) Pub. Date: May 12, 2011

(54) INTEGRATED CONTROL APPARATUS FOR HEATING, VENTILATING, AND AIR CONDITIONING SYSTEM FOR VEHICLE

(75) Inventors: Myung Hoe Kim, Seoul (KR); Seung Wook Kim, Hwaseong (KR); Jeong Yeop Lee, Daejeon (KR)

(73) Assignees: HYUNDAI MOTOR COMPANY, Seoul (KR); KIA MOTORS CORPORATION, Seoul (KR); HALLA CLIMATE CONTROL CORP., Daejeon (KR)

(21) Appl. No.: 12/786,719

(22) Filed: May 25, 2010

(30) Foreign Application Priority Data
Nov. 11, 2009 (KR) 10-2009-0108834

(51) Int. Cl. G05G 1/10

(52) U.S. Cl. 74/507

(57) ABSTRACT

The present invention provides an integrated control apparatus for a heating, ventilating, and air conditioning (HVAC) system for a vehicle in which a dual dial structure is applied to a dial type air conditioning control switch.

According to the integrated control apparatus for an HVAC system for a vehicle of the present invention, an air flow control knob and a temperature control knob are arranged in a concentric circle such that when the air flow control know is rotated, a blower shaft is thereby rotated to operate a blower switch, and the blower switch turns on or off a blower or controls the rotational speed of the blower, and when the temperature control knob is rotated, a rotating holder is thereby rotated with respect to the blower shaft and the amount of rotation is transmitted to a cable through a pin shaft, a gear shaft, and an internal gear to operate a temperature control cam, thus controlling the interior temperature.

### CROSS-REFERENCE TO RELATED APPLICATION

This application claims under 35 U.S.C. §119(a) the benefit of Korean Patent Application No. 10-2009-0108834 filed Nov. 11, 2009, the entire contents of which are incorporated herein by reference.

### BACKGROUND

(a) Technical Field

The present disclosure relates, generally, to an integrated control apparatus for a heating, ventilating, and air conditioning (HVAC) system for a vehicle. More particularly, it relates to an integrated control apparatus for an HVAC system for a vehicle in which a dual dial structure is applied to a dial type air conditioning control switch.

### (b) Background Art

A heating, ventilating, and air conditioning (HVAC) system is applied to a vehicle to provide a comfortable feeling to passengers by maintaining proper temperature, humidity, and air flow in response to changes in ambient environment.

Preferably, the HVAC system selectively introduces the inside or outside air by a blower according to opening and closing of an inside/outside switch door, passes the air through the surface of an evaporator along an air conditioning case to be cooled or passes the air through a heater core by an operation of a temperature control door to be heated, and discharges the cooled or heated air to a different compartment or areas of the interior of the vehicle through different vents by selectively opening and closing vent doors, thus cooling or heating the vehicle interior and defrosting the windshield and side glasses.

In such an HVAC system, the mixing ratio of the air passing through the evaporator and the air passing through the heater core is controlled by the temperature control door, and the discharge direction of the air flowing toward the vents is controlled by the vent doors installed in the respective vents. For example, the discharge of air is controlled in a vent mode for discharging the air toward the upper body of a passenger, in a foot mode for discharging the air toward the feet of the passenger, in a bi-level mode for simultaneously discharging the air to the upper body and the feet of the passenger, or in a defrost mode for discharging the air to the vehicle windows to defrost or defog the windows.

Preferably, a controller is mounted on a center fascia panel of the vehicle to allow a driver to select a desired mode from the above-described air conditioning modes.

FIG. 1 shows an example of a prior art controller which includes a variety of switches mounted on a housing that is inserted and fixed to the inside of the center fascia panel and a controller cover covering a front opening of the housing.

The switches preferably include an air direction control switch 101 for suitably rotating the vent doors in the vents by its operation, a heater control switch (or temperature control switch) 102 for suitably controlling the temperature of the vehicle interior by suitably controlling the opening degree of the temperature control door, an air flow control switch 103 for suitably controlling the rotational speed of a blower fan, and a cool/heat switch 104 for operating a cooling/heating cycle.

Preferably, the heater control switch 102 can be suitably divided into a cable-operated switch and an electrically operated switch according to the operating mode.

A prior art cable-operated heater control switch preferably includes a dial type knob, a gear shaft, and a gear lever.

Preferably, the knob is exposed to the outside of the control cover of the controller to be rotatably operated by a driver or a passenger, the gear shaft is connected to the knob, and the gear lever is engaged with the gear shaft and connected to the temperature control door via a cable.

According to a prior art cable-operated heater control switch having the above-described configuration, when the gear shaft is suitably rotated by the rotation of the knob, the gear lever engaged with the gear shaft is suitably rotated in an arc and the cable connected to the gear lever expands and contracts in connection therewith, thereby controlling the rotation of the temperature control door.

The structure of the air flow control switch for controlling the rotational speed of the blower fan has the same structure as the heater control switch.

Recently, a dual dial structure in which at least two of the heater control switch, the air direction and air flow control switches, and the cool/heat switch are suitably integrated into one structure has been developed and used in some luxury vehicles.

However, it is difficult to apply the dual dial structure to the prior art cable-operated switch in which the gear shaft and the gear lever are suitably rotated by the operating force of the knob to control the rotation of the temperature control door via the cable.

Accordingly, a separate structure is required to apply the dual dial structure to the cable-operated switch.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In preferred aspects, the present invention features an integrated control apparatus for a heating, ventilating, and air conditioning (HVAC) system for a vehicle, in which an air flow control knob and a temperature control knob are suitably arranged in a concentric circle such that when the air flow control knob is suitably rotated, a blower shaft is thereby rotated to operate a blower switch, and the blower switch turns on or off a blower or suitably controls the rotational speed of the blower, and when the temperature control knob is suitably rotated, a rotating holder is thereby rotated with respect to the blower shaft and the amount of rotation is suitably transmitted to a cable through a pin shaft, a gear shaft, and an internal gear to operate a temperature control cam, thus suitably controlling the interior temperature.

In a preferred embodiment, the present invention provides an integrated control apparatus for a heating, ventilating, and air conditioning (HVAC) system for a vehicle, the integrated control apparatus preferably including an air flow control knob and a temperature control knob rotatably mounted in a concentric circle with respect to a blower shaft; a blower switch suitably connected to a rear end of the blower shaft and rotated together with the rotation of the air flow control knob to turn on or off a blower or control the air flow; a gear shaft rotatably supported to the blower shaft and rotated together with the rotation of the temperature control knob; and an internal gear suitably engaged with the outer circumferential surface of the gear shaft and rotated to control the opening degree of a temperature control door via a cable.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing the configuration of a controller in a prior art heating, ventilating, and air conditioning system for a vehicle;

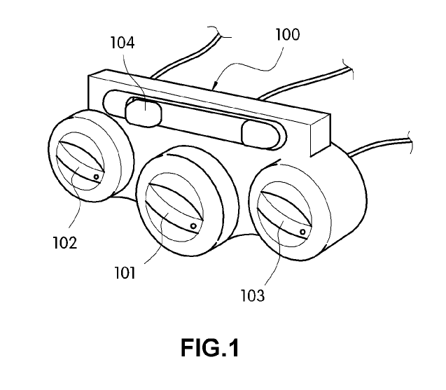

FIG. 2 is a perspective view showing an integrated control apparatus for a heating, ventilating, and air conditioning (HVAC) system for a vehicle in accordance with an exemplary embodiment of the present invention;

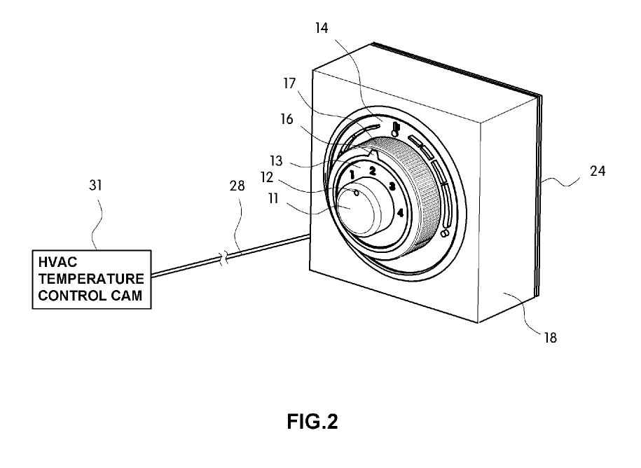

FIG. 3 is a rear perspective view of FIG. 2;

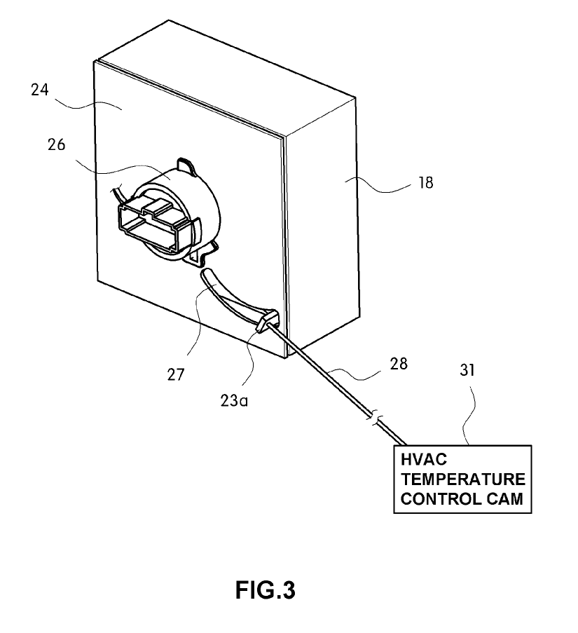

FIG. 4 is a perspective view showing an internal structure of the integrated control apparatus of FIG. 2 from which a housing is removed;

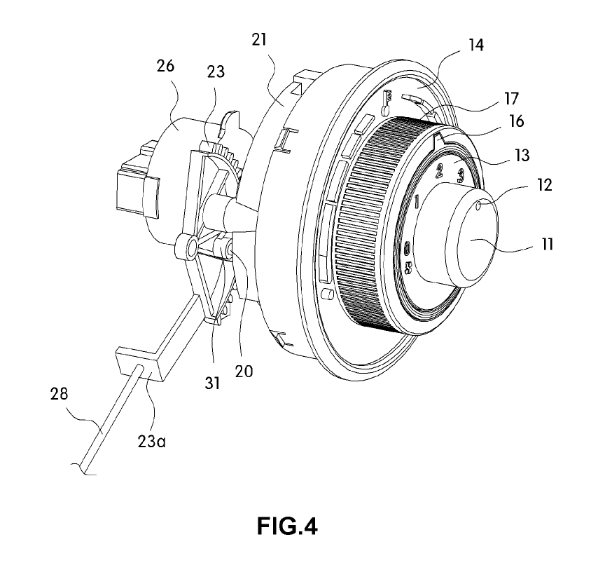

FIG. 5 is a rear perspective view taken from one side of FIG. 4;

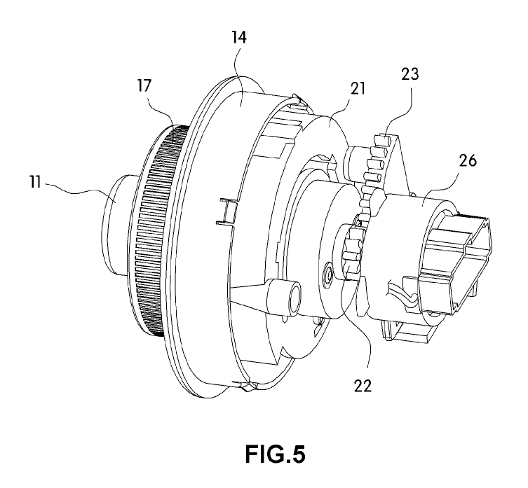

FIG. 6 is a perspective view showing the remaining parts of FIG. 5 from which a base lens is removed;

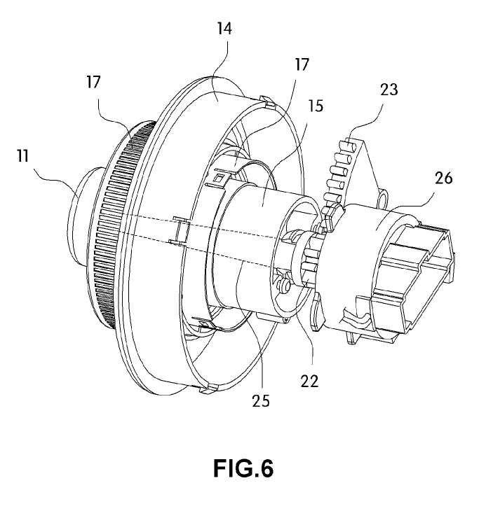

FIG. 7 is a rear perspective view taken from the other side of FIG. 4;

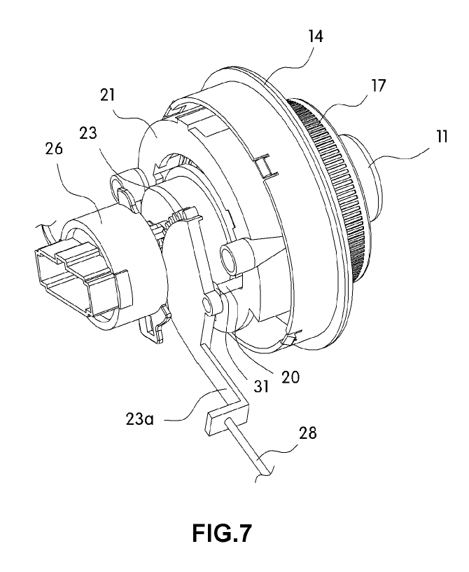

FIG. 8 is a perspective view showing the remaining parts of FIG. 7 from which a base lens is removed;

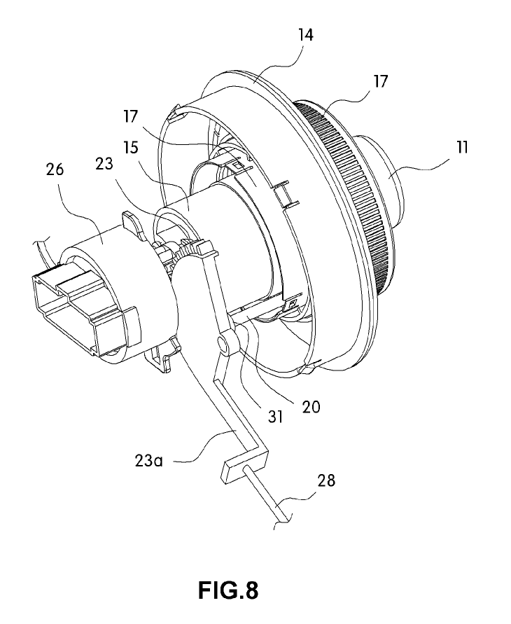

FIG. 9 is a cross-section view of FIG. 2; and

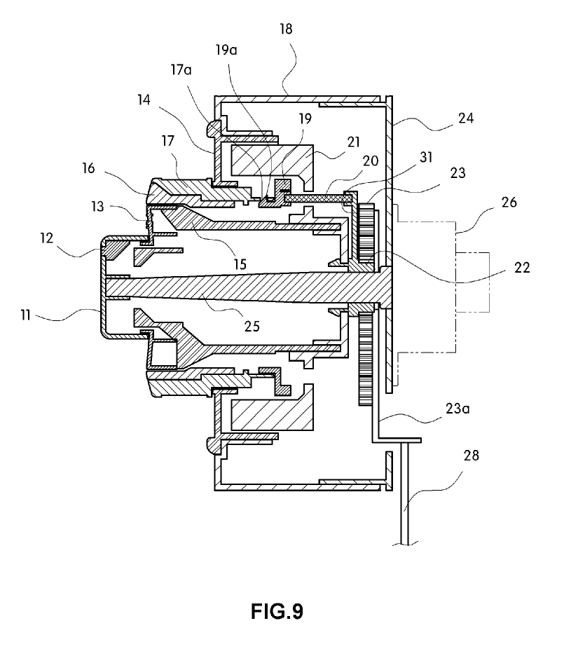

FIG. 10 is a perspective view showing an operating mechanism of an air flow control knob and a temperature control knob in accordance with an exemplary embodiment of the present invention.

Reference numerals set forth in the Drawings includes reference to the following elements as further discussed below:

| | |
|---|---|
| 10: air flow control switch | 11: air flow control knob |
| 12: air flow indicator | 13: air flow display cap |
| 14: holder | 15: lens guide |
| 16: temperature indicator | 17: temperature control knob |
| 17a: locking groove | 18: housing |
| 19: rotating holder | 19a: locking projection |
| 20: pin shaft | 21: base lens |
| 22: gear shaft | 23: internal gear |
| 23a: cable connecting portion | 24: cover |
| 25: blower shaft | 26: blower switch |
| 27: circular groove | 28: cable |
| 30: temperature control switch | 31: HVAC temperature control cam |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In one aspect, the present invention features an integrated control apparatus for a heating, ventilating, and air conditioning (HVAC) system for a vehicle, the integrated control apparatus comprising an air flow control knob and a temperature control knob arranged in a concentric circle, a blower shaft serving as a central axis of the temperature control knob, and a gear mechanism.

In one embodiment, the air flow control knob and the temperature control knob are arranged in a concentric circle on the inside and outside and are individually rotatably operated.

In another embodiment, the blower shaft is connected to a rear surface of the air flow control knob, and extends to the inside thereof, and rotates together with the knobs to operate a blower switch.

In another further embodiment, the gear mechanism is operated with the operation of the temperature control knob to operate an HVAC temperature control cam via a cable.

In still another further embodiment, the air flow control knob and the temperature control knob are formed with a mechanical dual dial structure.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

According to preferred embodiments, the present invention provides an integrated control apparatus for a heating, ventilating, and air conditioning (HVAC) system for a vehicle, in which at least two of an air flow control switch 10, an air direction control switch, a temperature control switch 30, and a cool/heat switch are suitably integrated into a dual dial.

Preferably, the integrated control apparatus for an HVAC system for a vehicle in accordance with an exemplary embodiment of the present invention has a dual dial structure in which the air flow control switch 10 and the temperature control switch 30 are suitably integrated.

According to certain exemplary embodiments, the integrated control apparatus preferably includes an air flow control knob 11, an air flow indicator 12, an air flow display cap 13, a holder 14, a lens guide 15, a temperature indicator 16, a temperature control knob 17, a housing 18, a rotating holder 19, a pin shaft 20, a base lens 21, a gear shaft 22, an internal gear 23, a cover 24, a blower shaft 25, and a blower switch 26.

Preferably, the air flow control knob 11 has a dial type rotating structure that a user holds and rotates to control the air flow, and a shaft insertion portion is suitably formed to project from the inner side surface of the air flow control knob 11.

According to further preferred embodiments, a front end of the blower shaft 25 is suitably inserted and fixed to the shaft insertion portion and a rear end of the blower shaft 25 is rotatably supported by the cover 24 of the housing 18 such that the air flow control knob 11 suitably rotates with respect to the center of the blower shaft 25.

According to certain preferred embodiments, the air flow indicator 12 is suitably inserted and fixed to a fixing hole that is formed on the inside front surface of the air flow control knob 11 to suitably indicate the speed of the air flow when the air flow is controlled from 0 to 4 steps.

Preferably, the air flow display cap 13 serves to display the speed of a blower controlled from 0 to 4 steps as numbers, and numbers from 0 to 4 are suitably marked at regular intervals in a circular direction on the front surface of the air flow display cap 13.

Here, the air flow display cap 13 is suitably fixed to a rear end of the air flow control knob 11, and a lower end of the air flow display cap 13 is suitably separated from the rear end of the air flow control knob 11 such that the air flow control knob 11 can suitably rotate. According to further preferred embodiments, an inner side end of the of the air flow display cap 13 is suitably connected to a front end of the lens guide 15.

Preferably, the lens guide 15 is suitably connected to a rear end of the air flow display cap 13 to receive light from the base lens 21 and suitably transmit the light to the air flow display cap 13 and the air flow indicator 12 such that the user can easily control the air flow in a dark place or during a night drive.

Preferably, the temperature indicator 16 serves to set the temperature during operation of the temperature control knob 17, and the temperature control knob 17 has a dial type rotating structure that the user holds and rotates to suitably control the interior temperature.

According to further preferred embodiments, the temperature indicator 16 and the temperature control knob 17 are rotatably mounted in a concentric circle, and the temperature indicator 16 is suitably disposed in the inside of the temperature control knob 17.

Preferably, the dual dial structure includes the temperature control knob 17 projecting a predetermined distance from the housing 18 and rotatably mounted and the air flow control knob 11 rotatably mounted in a concentric circle with the temperature control knob 17 and projecting a predetermined distance further from the temperature control knob 17.

According to certain preferred embodiments, the air flow control knob 11 and the temperature control knob 17 rotate with respect to the same blower shaft 25 as a central axis on the inside and outside.

Preferably, the air flow display cap 13, the temperature indicator 16, and the temperature control knob 17 have the same projection length.

In further preferred embodiments, the holder 14 serves to suitably display the temperature set by the temperature indicator 16 and further to rotatably support the temperature control knob 17 so as to mount the temperature control knob 17 and the air flow control knob 11 on the housing 18.

According to certain preferred embodiments of the present invention, a cooling temperature display for controlling the cooling temperature is suitably formed at the left side with respect to the center of the front surface of the holder 14 and a heating temperature display for controlling the heating temperature is suitably formed at the right side symmetrically with the cooling temperature display.

Preferably, the cooling temperature display and the heating temperature display are all formed in a circular shape, in which the area is increased from the top to the bottom. According to certain exemplary embodiments, the cooling temperature display is shown in blue and the heating temperature display is shown in red such that the user can easily recognize that the cooling temperature is further reduced when turning the temperature control knob 17 counterclockwise and the heating temperature is further increased when turning the temperature control knob 17 clockwise.

Preferably, the base lens 21 is mounted on the inside of the holder 14 to suitably transmit the light to the cooling and heating temperature displays formed on the front surface of the holder 14 such that the user can easily control the interior temperature in a dark place or during a night drive.

In certain exemplary embodiments, the rotating holder 19 is preferably connected to a rear end of the temperature control knob 17 to suitably transmit the rotational force to the pin shaft 20 by the rotation of the temperature control knob 17. Preferably, a locking groove 17a is suitably formed at a rear end of the temperature control knob 17 and a locking projection 19a is suitably formed at a front end of the rotating holder 19 such that when the locking projection 19a is suitably connected to the locking groove 17a, the rotating holder 19 is rotated together with rotation of the temperature control knob 17.

According to further preferred embodiments, the pin shaft 20 is suitably connected in parallel to the blower shaft 25 on the rear side of the rotating holder 19 such that the rotational force of the temperature control knob 17 is suitably transmitted to the pin shaft 20 through the rotating holder 19.

Preferably, the base lens 21 serves as a main lens which receives light from two light sources and suitably transmits the light to the cooling and heating temperature displays, the air flow display cap 13, the temperature indicator 16, and the air flow indicator 12, thus brightening the displayed air flow and temperature.

In certain exemplary embodiments, the base lens 21 preferably includes a large diameter portion inserted into the inside of the holder 14 and a small diameter portion projecting backward from a rear end of the large diameter portion. Preferably, the rotating holder 19 is suitably inserted and mounted in the inside of the large diameter portion, and the rear end of the lens guide 15 is suitably connected to the inside of the small diameter portion.

According to certain preferred embodiments, the gear shaft 22 serves to transmit the rotational force of the pin shaft 20 to the internal gear 23 and preferably includes a gear formed on the outer circumferential surface of the gear shaft 22. Preferably, the gear shaft 22 is suitably inserted and assembled into the rear end of the blower shaft 25 through a central hole thereof and is suitably connected to the rear end of the pin shaft 20 by a connection piece 31 projecting from the outer side surface of the gear shaft 22 in the outer circumferential direction such that the rotational force of the pin shaft 20 is suitably transmitted to the gear shaft 22 through the connection piece 31.

According to further exemplary embodiments, the internal gear 23 has a fan-shaped plate shape such that it is suitably engaged with the gear shaft 22 through a gear formed on a circular surface to be rotated together with the rotation of the gear shaft 22.

Preferably, a cable connecting portion 23a is suitably formed to project from an edge of the internal gear 23 in a tangential direction such that a cable 28 is suitably connected to a bent portion formed at the end of the cable connecting portion 23a.

In further preferred embodiments, the housing 18 covers parts other than the air flow control knob 11, the temperature control knob 17, the parts covered by the air flow control knob 11 and the temperature control knob 17, and the blower switch 26 to protect the corresponding parts from an external force.

According to certain preferred embodiments of the present invention, the air flow control knob 11 and the temperature control knob 17 are mounted on the front surface of the housing 18 to be suitably exposed to the outside such that the user can manipulate them, and the cover 24 is mounted on the rear of the housing 18 to cover the rear of the housing 18.

Preferably, the rear end of the blower shaft 25 is rotatably mounted on the cover 24.

In further preferred embodiments, the blower switch 26 is suitably connected to the rear end of the blower shaft 25 to turn on or off a blower or control the rotational speed of the blower.

The operation and effect of the integrated control apparatus for an HVAC system for a vehicle having the above-described configuration in accordance with an exemplary embodiment of the present invention is described herein.

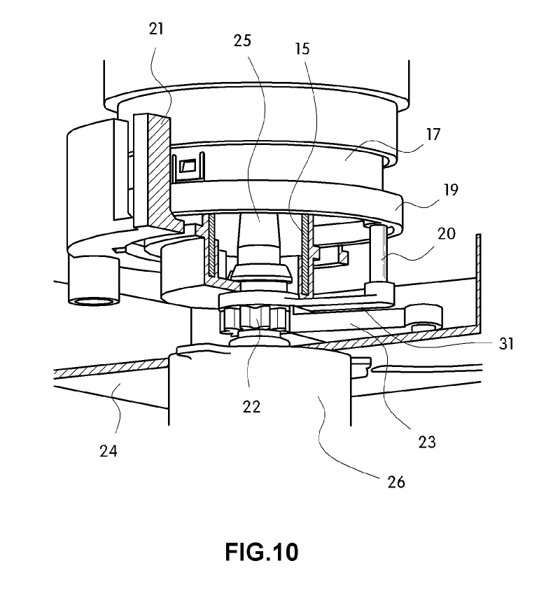

FIG. 10 is a perspective view showing an operating mechanism of the air flow control knob and the temperature control knob in accordance with an exemplary embodiment of the present invention.

Preferably, the air flow control switch 10 and the temperature control switch 30 in accordance with an exemplary embodiment of the present invention are integrated into a dual dial structure capable of rotating in a concentric circle. According to preferred embodiments, the air flow control switch 10 electrically operates the blower, and the temperature control switch 30 mechanically operates an HVAC temperature control cam 31 using a cable, thus suitably controlling the interior temperature.

1. Air Flow Control Switch 10

According to an exemplary embodiment of the present invention, the user can turn on or off the blower or control the air flow by suitably rotating the air flow control knob 11, exposed to the outside of the housing 18, right and left to position the air flow indicator 12 at a desired position from 0 to 4 steps displayed on the air flow display cap 13.

Preferably, when the air flow control knob 11 is suitably rotated, the blower shaft 25 connected to the air flow control knob 11 rotates to change the contact position of the blower switch 26 suitably connected to the blower shaft 25, and thereby different electrical signals are generated to change the operating voltage for an actuator for controlling the air flow. Accordingly, as a result, the blower is turned on or off or the speed of the blower for controlling the air flow is controlled.

2. Temperature Control Switch 30

In another exemplary embodiment of the invention, the user can control the opening degree of the temperature control door by suitably rotating the temperature control knob 17, exposed to the outside of the housing 18, right and left to position the temperature indicator 16 at a desired position of the graphic displayed on the temperature display.

Preferably, the rotational force of the temperature control knob 17 is suitably transmitted in such an order that the rotating holder 19, the pin shaft 20, the connection piece 31, the gear shaft 22, the internal gear 23, and the cable connecting portion 23a. Further, the cable connecting portion 23a rotates in an arc at a predetermined angle along a circular groove 27 suitably formed on the rear of the cover 24 of the housing 18, and the cable 28 moves in a straight line a desired distance such that the HVAC temperature control cam 31 connected to the end of the cable 28 is operated, thus controlling the interior temperature.

Preferably, in this case, the straight movement and distance of the cable 28 can be suitably controlled by the gear ratio of the gear shaft 22 and the internal gear 23.

The transmission mechanism of the gear shaft 22 and the internal gear 23 according to the rotation of the temperature control knob 17 are described in more detail below.

According to preferred embodiments of the present invention, the rotating holder 19 and the pin shaft 20 are suitably connected to the rear end of the temperature control knob 17 and rotated together with the rotation of the temperature control knob 17 with respect to the same blower shaft 25, and the connection piece 31 projects from the outer circumferential surface of the gear shaft 22 in the outer circumferential direction to connect the pin shaft 20 and the gear shaft 22 such that the rotational force of the temperature control knob 17 is suitably transmitted to the gear shaft 22 through the rotating holder 19, the pin shaft 20, and the connection piece 31.

Accordingly, consequently, the internal gear 23 is suitably engaged with the gear shaft 22 at a predetermined gear ratio and rotated at a predetermined angle, and the cable 28 connected to the cable connecting portion 23a formed to project from the internal gear 23 in the tangential direction is moved a predetermined distance such that the HVAC temperature control cam 31 connected to the opposite end of the cable 28 is operated, thus controlling the interior temperature.

According to the above-described operation state, the air flow control switch 10 can electrically control the blower through the actuator, and the temperature control switch 30 can mechanically control the opening degree of the temperature control door using the cable by the above-described mechanism.

As described herein, the integrated control apparatus for an HVAC system for a vehicle in accordance with preferred embodiments of the present invention has, but is not limited only to, the following advantages and effects:

According to certain preferred embodiments of the present invention as described herein, to implement the dual dial structure in which the temperature control switch and the air flow control switch are rotatably mounted in a concentric circle, the air flow control knob is directly connected to the blower switch by the blower shaft, and thereby it is possible to electrically control the blower by the actuator. According to further preferred embodiments of the present invention, as the temperature control knob is suitably rotated with respect to the blower shaft, the rotational force is transmitted to the cable through the gear shaft and the internal gear, and thereby it is possible to mechanically control the opening degree of the temperature control door using the cable;

According to other preferred embodiments of the present invention as described herein, while the existing electric dual dial structure requires two actuators, the present invention preferably employs the dual dial structure in which the electric air flow control switch and the cable-operated temperature control switch are suitably integrated into one structure, and thereby it is possible to eliminate the two actuator, which results in a reduction in manufacturing cost; and

According to other certain preferred embodiments of the present invention as described herein, it is possible to apply the dual dial structure, in which the electric and cable-operated switches are suitably integrated, to low cost compact vehicles without an increase in the cost.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An integrated control apparatus for a heating, ventilating, and air conditioning (HVAC) system for a vehicle, the integrated control apparatus comprising:
an air flow control knob and a temperature control knob arranged in a concentric circle on the inside and outside and individually rotatably operated;
a blower shaft serving as a central axis of the temperature control knob, connected to a rear surface of the air flow control knob, extending to the inside thereof, and rotated together with the knobs to operate a blower switch; and
a gear mechanism operated with the operation of the temperature control knob to operate an HVAC temperature control cam via a cable,
wherein the air flow control knob and the temperature control knob are formed with a mechanical dual dial structure.

2. The integrated control apparatus of claim 1, wherein the gear mechanism comprises:
a gear shaft connected to a rear surface of the temperature control knob and, at the same time, inserted and assembled into the blower shaft to be rotated together with the operation of the knob; and
an internal gear rotatably mounted on a housing while being engaged with the gear shaft and operating the cable by the engagement with the gear shaft.

3. The integrated control apparatus of claim 1, wherein the gear shaft of the gear mechanism includes a connection piece having a predetermined length extending in a radial direction and is connected to the temperature control knob by a pin shaft connected between a rotating holder disposed in parallel on the circumference of the blower shaft and mounted on a rear surface of the temperature control knob and the connection piece.

4. The integrated control apparatus of claim 1, wherein the cable moves in a straight line a desired distance, and the straight movement and distance of the cable is controlled by a gear ratio of the gear shaft and the internal gear.

5. The integrated control apparatus of claim 2, wherein the internal gear has a fan-shaped plate shape.

6. The integrated control apparatus of claim 2, wherein the internal gear comprises a cable connecting portion formed at an edge of the internal gear in a tangential direction and the cable is connected to an end of the cable connecting portion.

7. The integrated control apparatus of claim 1, wherein the rotating holder comprises a locking projection formed at a front end thereof and connected to a locking groove formed at a rear end of the temperature control knob such that the rotating holder is rotated together with the temperature control knob.

8. The integrated control apparatus of claim 1, further comprising a base lens mounted on an inside of a holder including cooling and heating temperature displays formed on a front surface thereof to transmit light to the cooling and heating temperature displays of the holder and a lens guide mounted on an inside of the air flow control knob to receive light from the base lens and transmit the light to an air flow display cap and an air flow indicator.

9. An integrated control apparatus for a heating, ventilating, and air conditioning (HVAC) system for a vehicle, the integrated control apparatus comprising:
an air flow control knob and a temperature control knob arranged in a concentric circle;
a blower shaft serving as a central axis of the temperature control knob; and
a gear mechanism.

10. The integrated control apparatus of claim 9, wherein the air flow control knob and the temperature control knob are arranged in a concentric circle on the inside and outside and are individually rotatably operated.

11. The integrated control apparatus of claim 9, wherein the blower shaft is connected to a rear surface of the air flow control knob, and extends to the inside thereof, and rotates together with the knobs to operate a blower switch.

12. The integrated control apparatus of claim 9, wherein the gear mechanism is operated with the operation of the temperature control knob to operate an HVAC temperature control cam via a cable.

13. The integrated control apparatus of claim 9, wherein the air flow control knob and the temperature control knob are formed with a mechanical dual dial structure.
